(19) United States
(12) Patent Application Publication
(10) Pub. No.: US 2008/0305339 A1
(43) Pub. Date: Dec. 11, 2008

(54) Thin molded article

(75) Inventor: Daizo Kotaki, Ashikaga-shi (JP)

Correspondence Address: DAY PITNEY LLP, 7 TIMES SQUARE, NEW YORK, NY, 10036-7311, US

(73) Assignee: KABUSHIKI KAISHA DAISAN

(21) Appl. No.: 12/157,379

(22) Filed: Jun. 10, 2008

(30) Foreign Application Priority Data
Jun. 11, 2007 (JP) JP2007-179012
Sep. 14, 2007 (JP) JP2007-269498

(51) Int. Cl. B32B 3/30

(52) U.S. Cl. 428/409

(57) ABSTRACT

The thin molded article of the present invention includes a thin flat plate 1 and dam/discharge ribs 6 provided on the thin flat plate having a shape in which bar-type ribs having wide or large diameters extend radially from the center of the molded article. The tips of the bar-type ribs having wide or large diameters have a shape that allows the molten resin injected from a gate into a cast to be accumulated temporarily before it flows into said thin plate, thereby providing a configuration in which the tips of said ribs do not reach the outer edge of the molded article.

### BACKGROUND OF THE INVENTION

1. Field of the Invention

The present invention, being applicable to thin plastic products, is associated with molded articles, such as flat plate type film sheets or various containers, and the like. In particular, it provides a molded article having a shape suited to accurately mold thin plates or boxes that are free of deformation or non-uniform thicknesses.

2. Description of the Prior Art

Conventionally, in order to produce thin flat plates or boxes free from warps and deformation, it was common to mold them using the vacuum technology or the like that makes their structure complicated in effect. The ultra-thin plastic molding of one millimeter (1 mm) or less had drawbacks, even with the manipulation of vacuum technology, such as lack of drawing the vacuum effect due to its thinness, difficulty in removing the molded product from the mold due to the vacuum effect, and necessity for large equipment.

### SUMMARY OF THE INVENTION

To overcome the drawbacks, the present invention intends to produce a thin molded product by injection molding which has the following advantages over vacuum molding:

1. A deep configuration, which cannot be vacuumed, can be molded;

2. It is likely that a thickness of 0.6 mm is the limitation for vacuuming the deep object made of sheet members: at a thickness of 0.4 mm, holes are found at corner sections. The thin injection molding makes the molding at a 0.4 mm level possible with some cast modification;

3. Vacuum molding produces only the uniform thickness; injection molding can purposely vary thicknesses in part of a molded article. Hence, injection molding can produce a molded article of a complex configuration; and

4. Injection molding is significantly accurate in sizing as compared to vacuum molding, therefore can be applied to molding of various types of articles.

However, there has been a common belief that injection molding of conventional technology might not be suited to thin molding of less than 1 mm due to the following drawbacks that result from injection molding:

1. Low pressure injection of a molten resin is effective but the material does not reach the end of the thin plate due to the lack of injection pressure and, part of the thin plate section fell off or chipped off at a distant end of the center of the thin plate section;

2. Increasing the pressure of molten resin injection, in order to prevent part of the thin plate section from falling or chipping off, improved falling or chipping off of the thin flat plate section. Nonetheless, high pressure molding caused deformation of the thin flat plate section, or, in an extreme case, the outer edge of the thin flat plate section burred;

3. To inject the molten resin into the very end of the thin flat plate section, there is an alternative method in which the resin temperature is increased to improve fluidity of the resin; however, the gas or air generated by the high temperature molten resin accumulates in a mold and the molten resin does not reach all the way to the end of the thin flat plate, which is a drawback; and

4. Particularly in the case of thin molding, injection molding caused variation in thickness and a thin flat plate had a non-uniform thickness depending on the precision of a mold or the performance of a molder.

In order to overcome the above drawbacks (1)-(4), the present invention utilized the dam/discharge ribs or flow ribs for injection molding of thin molded articles.

Although, there is a conventional technology in which part of flat plates forms concavities (convexities when viewed from the opposite surface) that enhance the strength of the flat surface, the concavities simply enhance ribs. The concavities never provide the effect of dam/discharge ribs through which the molten resin is accumulated temporarily before being discharged during molding. It never provides another effect of dam/discharge ribs comprising large diameter or wide ribs through which the molten resin is flowed on a flat plate uniformly to prevent the thicknesses from deviating.

There is also an alternative in a configuration, as suggested in Japanese Unexamined Patent Application Publication No. 2005-112398: in order to sustain the strength of the bottom plate other than reinforcement ribs, the regions in which ribs of a given width extending toward the four side wall directions from the center region of the bottom plate of a plastic carrying containers are allowed to intersect to form regions that are thicker than other regions. However, absent is the idea which is similar to the dam/discharge ribs that allow the molten resin, which is injected from a gate into a mold, to be accumulated temporarily before being discharged into a molded article. Therefore, applications of this conventional technology are limited by the fluidity of the molten resin to only thick molded articles such as containers having a thickness of over several millimeters.

Moreover, the applicant of the present invention disclosed the effects of dam/discharge ribs of the present invention in Japanese Unexamined Patent Application Publication No. Hei 6-87174. Nevertheless, the thin molding of the present invention provides different effects as described below:

In the case of the net filter of Japanese Unexamined Patent Application Publication No. Hei 6-87174, since the male and female molds are completely linearly fastened, the possibility of causing thickness variations is eliminated, and the contact area thereof remains smaller than that of flat plates; therefore, it provides only the effect that a molten resin is accumulated temporarily in fine grooves on dam/discharge ribs of the filter, and is then discharged strongly. On the other hand, the dam/discharge ribs which is applied to the thin molded article of the present invention provides, in effect, not only the temporary accumulation of a molten resin in fine grooves on dam/discharge ribs of the filter before forceful discharging but also the uniform distribution of the molten resin on the entire flat plate without disturbance of thickness variations on the thin flat plate. In the case of the thin molded article, the presence of many hollow sections causes the molten material to be discharged in a displaced direction, thus causing further thickness variations. It is the role of the dam/discharge ribs in the thin molding that prevents thickness variations. In other words, a plurality of bar-type dam/discharge ribs arranged radially on a flat plate allows the molten resin to be distributed uniformly throughout the thin flat plates without thickness variations. The present invention is also intended to provide the dam/discharge ribs together with supplementary large diameter or wide flow ribs to secure the suppression of thickness variations and the injection molding of an article of a thickness less than 1 mm.

### Problems the Invention Intends to Solve

The thin flat plate molded articles made by injection molding or fully molded thin containers, such as film sheets or figure skate cases, have the following problems:

1. A structure that allows the molten resin to be distributed uniformly throughout the molded article is required.

2. A structure that enhances the fluidity of the molten resin in the mold during injection molding is required. To fulfill this requirement, a structure that allows low pressure molding and that does not cause low pressure molding derived shrinkage at thin sections is required.

3. Thickness variations occur in thin sections depending on the precision of the mold or molder, which needs to be prevented by choosing the right mold structure.

For this reason, the present invention intends to overcome the drawbacks of injection molding observed during conventional molding of thin molded articles by using the means described below.

### Means to Solve the Problems

The thin molded article of the present invention is characterized as follows:

In one embodiment, the present invention is a thin molded article that is thin and flat which is characterized by the fact that it comprises:

(a) a thin flat plate; and

(b) dam/discharge ribs provided on said thin plate having a shape in which bar-type ribs having wide or large diameters extend radially from the center of the molded article; the tips of said bar-type ribs having wide or large diameters have a shape that allows the molten resin injected from a gate into a cast to be accumulated temporarily before it flows into said thin plate, thereby providing a configuration in which the tips of said ribs do not reach the outer edge of the molded article.

In a second embodiment, the present invention is a thin molded plastic article in the form of a thin box which is characterized by the fact that it comprises:

(a) a thin flat box; and

(b) dam/discharge ribs provided on the top surface or the bottom surface of said thin box having a shape in which wide or large diameter bar-type ribs extend radially from the center of said top surface or bottom surface in such a manner that the tips of said wide or large diameters bar-type ribs allow the molten resin injected from a gate into a cast to be accumulated temporarily before it is flown into said thin box, thereby providing a configuration in which the tips of said ribs do not reach the outer edge of said top surface or bottom surface of the molded article.

In a third embodiment, the present invention is directed toward a thin plastic molded article of the thin and flat box type which is characterized by the fact that it comprises:

(a) a thin box;

(b) hollow cylindrical housing sections provided on the top surface or bottom surface of said thin box to store articles and the like; and

(c) dam/discharge ribs which are provided on the top surface or bottom surface of said thin box and has a shape in which wide or large diameter bar-type ribs extend radially from the center of said top surface or bottom surface in such a manner that the tips of said wide or large diameters bar-type ribs allow the molten resin injected from a gate into a cast to be accumulated temporarily before it is flown into said thin box, thereby providing a configuration in which the tips of said ribs do not reach the outer edge of said top surface or bottom surface; and which are provided between said hollow cylindrical housing sections.

The dam/discharge ribs in these three embodiments may be in a cross shape or X-shape.

Moreover, the top surface or bottom surface of the thin plate or thin box structure of the present invention may have ring-shaped flow ribs of large diameter or wide ribs to enclose the tips of dam/discharge ribs radially extending from the center section of the molded article.

Further, the top surface or bottom surface of the thin plate or thin box structure of the present invention may comprise:

(a) ring-shaped flow ribs of large diameter or wide ribs which enclose the tips of dam/discharge ribs radially extending from the center section of the molded article; and

(b) auxiliary flow ribs of large diameter or wide bar-type ribs that are radially coupled with said ring shaped flow ribs.

In addition, the side walls of a thin box structure of the present invention may have a plurality of side wall flow ribs of large diameter or wide bar-type ribs having a shape in which the tips of said ribs do not reach the outer edge of the side walls.

Finally, the thin molded article of the present invention may have a plurality of flange section flow ribs of large diameter or wide bar-type ribs having a shape in which the tips of said ribs do not reach the outer edge of the side walls or flange section.

### EFFECTS OF THE INVENTION

In the several embodiments of the present invention, in order to temporarily accumulate the molten resin before it is discharged into a thin flat plate or thin box, there are dam/discharge ribs having a configuration in which their both ends do not reach the periphery of the molded article; the dam/discharge ribs made the use of low pressure molding possible. Accordingly, the thin molding involving a thickness of 1 mm or less does not require large equipment and renders molded articles that are free of warps and incomplete filling of the resin.

Moreover, the formation of dam/discharge ribs allows the molten resin in the mold to flow significantly smoothly and enables full injection molding of large thin plastic molded articles.

The formation of cross-shaped or X-shaped dam/discharge ribs allows the molten resin flow to be fully supplied to the periphery or corner sections of the molded article where the molten resin flow is difficult or slows down. Hence, a molded article that does not suffer from incomplete filling of the resin or warps can be provided.

Flow ribs having large diameter or wide ribs that are arranged in a ring-shape are provided. Therefore, dam/discharge ribs and flow ribs which are responsible for powerful injection of the molten resin operate jointly; as a result, dam/discharge ribs allow the resin to be completely filled into a thin molded article by low pressure molding while the flow ribs allow the molten resin to be uniformly distributed all the way to the end of the molded article without causing thickness variations.

Bar-type flow ribs are provided in addition to the ring-shaped flow ribs. Therefore, the joint operation between the bar-type flow ribs and the ring-shaped flow ribs allows the molten resin to be even more uniformly distributed to the end without causing thickness variations.

Flow ribs of ring-shaped or bar-type large diameter or wide ribs are provided on the side walls or flange section of a box (including cylinder). This means that side wall flow ribs and flange section flow ribs are provided so as to receive the flow from dam/discharge ribs, which forcefully inject the molten resin, and further preferentially flow toward the side walls or flange sections where the molten resin flows with difficulty; these are effective in manufacturing three-dimensional thin molded articles.

### BRIEF DESCRIPTION OF DRAWINGS

FIG. 1 is a plan view showing the thin flat plate of the present invention;

FIG. 2 is a plan view showing another modified embodiment the thin flat plate of the present invention;

FIG. 3 is a cross-sectional view, taken as indicated by line A-A′ in FIG. 1, showing the thin flat plate of the present invention;

FIG. 4 is a cross-sectional view, taken as indicated by line A-A′ in FIG. 1, showing another modified embodiment of the thin flat plate of the present invention;

FIG. 5 is a cross-sectional view, taken as indicated by line B-B′ in FIG. 2, showing another modified embodiment of the thin flat plate of the present invention;

FIG. 6 is a cross-sectional view, taken as indicated by line B-B′ in FIG. 2, showing another modified embodiment of the thin flat plate of the present invention;

FIG. 7 is a plan view showing the thin box of the present invention;

FIG. 8 is a plan view showing another modified embodiment the thin box of the present invention;

FIG. 9 is a cross-sectional view, taken as indicated by line C-C′ in FIG. 7, showing the thin box of the present invention;

FIG. 10 is a cross-sectional view, taken as indicated by line C-C′ in FIG. 7, showing another modified embodiment of the thin box of the present invention;

FIG. 11 is a cross-sectional view, taken as indicated by line D-D′ in FIG. 7, showing another modified embodiment of the thin box of the present invention;

FIG. 12 is a cross-sectional view, taken as indicated by line D-D′ in FIG. 7, showing another modified embodiment of the thin box of the present invention;

FIG. 13 is a plan view showing the principle of the dam/discharge ribs of the present invention;

FIG. 14 is a cross-sectional view, taken as indicated by line E-E′ in FIG. 13, showing a shape of the dam/discharge ribs of the present invention;

FIG. 15 is a cross-sectional view, taken as indicated by line E-E′ in FIG. 13, showing a shape of the dam/discharge rib of the present invention;

FIG. 16 is a cross-sectional view, taken as indicated by line E-E′ in FIG. 13, showing a shape of the dam/discharge rib of the present invention;

FIG. 17 is a cross-sectional view, taken as indicated by line E-E′ in FIG. 13, showing a shape of the dam/discharge rib of the present invention;

FIG. 18 is a cross-sectional view showing the mold which is used for describing the molding state of the present invention;

FIG. 19 is a plan view showing another modified embodiment of the thin box of the present invention;

FIG. 20 is a cross-sectional view, taken as indicated by line F-F′ in FIG. 19, showing another modified embodiment of the thin box of the present invention;

FIG. 21 is a plan view showing another modified embodiment of the thin box of the present invention;

FIG. 22 is a cross-sectional view, taken as indicated by line G-G′ in FIG. 21, showing another modified embodiment of the thin box of the present invention;

FIG. 23 is a plan view showing another modified embodiment of the thin box of the present invention;

FIG. 24 is a cross-sectional view, taken as indicated by line H-H′ in FIG. 23, showing another modified embodiment of the thin box of the present invention;

FIG. 25 is a plan view showing another modified embodiment of the thin box of the present invention;

FIG. 26 is a cross-sectional view, taken as indicated by line I-I′ in FIG. 25, showing another modified embodiment of the thin box of the present invention;

FIG. 27 is a plan view showing another modified embodiment of the thin box of the present invention; and

FIG. 28 is a cross-sectional view, taken as indicated by line J-J′ in FIG. 27, showing another modified embodiment of the thin box of the present invention.

### DETAILED DESCRIPTION OF THE PREFERRED EMBODIMENTS

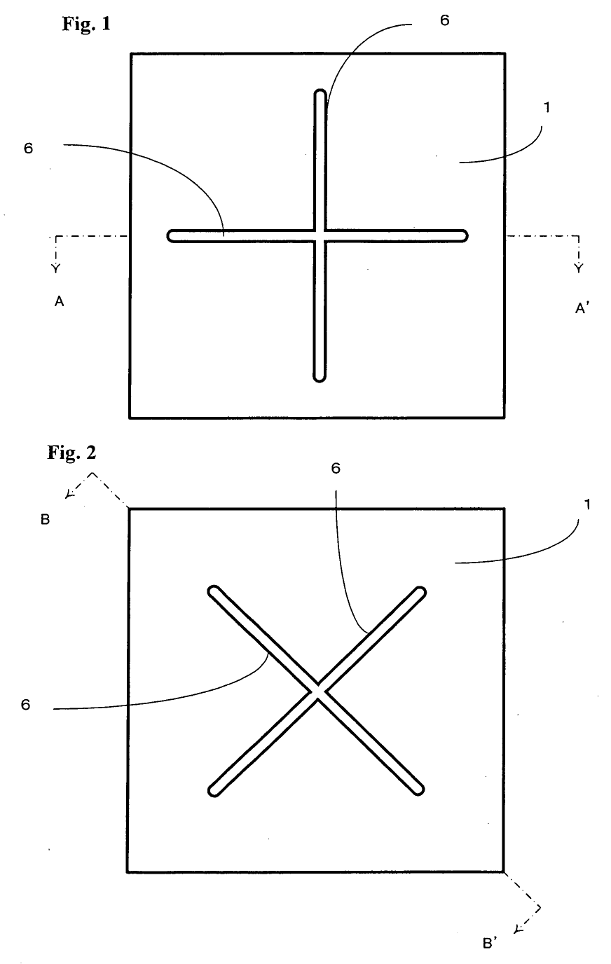

FIG. 1 shows an example of the plastic molded article having the thin flat structure of the present invention. A plurality of dam/discharge ribs 6 extending from the center section of thin flat plate 1 toward its outer edge constitutes cross-shaped dam/discharge ribs 6. These dam/discharge ribs 6 are large diameter or wide ribs that promote the flow of a molten resin in a mold. Provided on or in the center of the cross-shaped ribs is a gate (not illustrated) to inject the molten resin into the mold. The molten resin flowing from the gate to dam/discharge ribs 6 is discharged toward the outer edge and also onto thin flat plate 1 from the periphery of the ribs.

Large diameter dam/discharge ribs 6 are configured as follows: they are provided from the center section of the thin flat plate toward the outer edge radially, and the tips of dam/discharge ribs 6 are formed so that they do not reach the outer edge; as a result, the molten resin to be injected to the mold accumulates a given pressure thereon and is pressed into thin flat plate 1 from the peripheral and tips of dam/discharge ribs 6, thereby ensuring the molten resin's discharge to the end of thin flat plate 1. This configuration provides excellent effects of enabling molding of an article requiring a thin flat plate having a thickness of 1 mm or less, and also of increasing the number of molding shots, subsequently increasing the success rate significantly.

The present invention can be applied to molded articles such as film sheets for containing papers, name plate cases, thin lids, and the like. General polypropylene or acrylic materials can be used for the resin.

As FIG. 2 illustrates, a plurality of bar-type dam/discharge ribs 6 is X-shaped pointing toward the corners of thin flat plate 1, and the tips of dam/discharge ribs are pointed toward corner sections into which the molten resin flows with difficulty. Since dam/discharge ribs 6 are of the bar type, the amount of the molten resin discharged to thin flat plate 1 is greater at the tip sections than that from the periphery. For this reason, this type has the effect that the molten resin is filled into the corner sections of thin flat plate 1 in which the molten resin is less likely to be filled first.

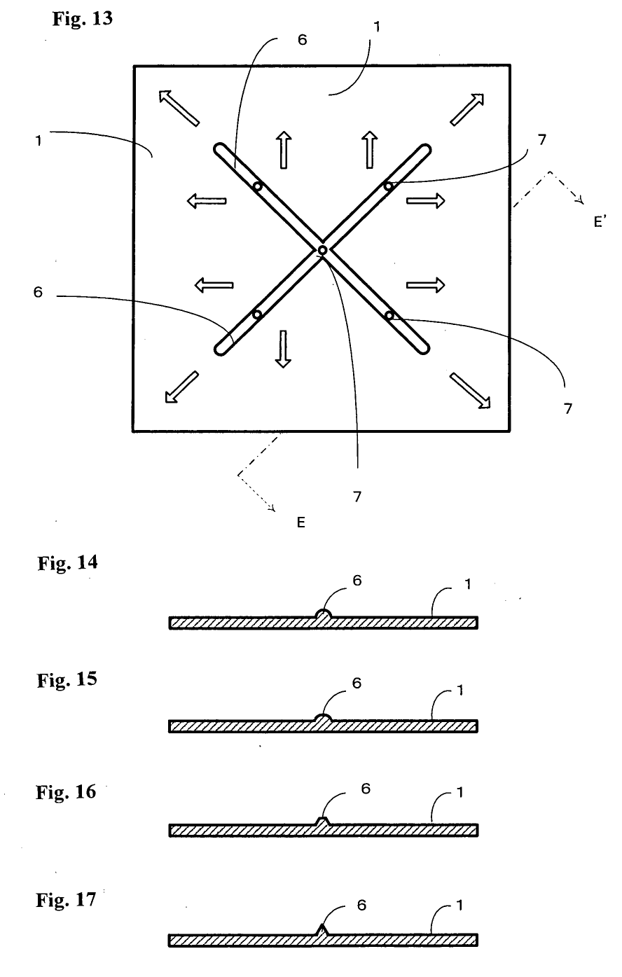

The operation and effects of the dam/discharge ribs are described in detail with reference to FIG. 13.

Gate 7 is provided at the intersections of X-shaped dam/discharge ribs 6. And the molten resin which is injected from this gate 7 is filled toward the tip of dam/discharge ribs 6 which extend in four directions. At this time, the molten resin is filled within large diameter or wide dam/discharge ribs 6 but its flow toward the peripheral of the thin area becomes difficult due to the difference in thicknesses. This operation causes the molten resin to accumulate a given pressure within dam/discharge ribs 6. And because the low pressure is continuously applied to the molten resin in dam/discharge ribs 6, the molten resin is forcefully discharged to a thin section on thin flat plate 1. In this discharge, the discharging force is strong for the molten resin that has been accumulated within dam/discharge ribs 6, and it is this strong discharging force that spreads the molten resin to the end of thin flat plate 1. Dam/discharge ribs 6 and thin flat plate are integrally formed, which allows the molten resin discharged from dam/discharge ribs 6 to be discharged from the entire circumference of the bar-type ribs of dam/discharge ribs as marked with an arrow. Nevertheless, according to the molten resin law in which the resin within the mold is discharged preferentially from the area where it is discharged with ease, the resin is discharged preferentially toward the tips of bar-type ribs of dam/discharge ribs 6. Accordingly, there is an effect to accelerate the flow toward the outer edge or corner sections of thin flat plate 1 where the molten resin flow slows down.

Furthermore, when the area of a thin molded article is large, a plurality of gates 7 is allowed to be formed at symmetrical positions in the vicinity of the tip sections of ribs of dam/discharge ribs 6. When the area of a molded article is large, a single gate renders the molten resin flow difficult; therefore, multi-point gates may be provided to solve the fluidity issue. Multi-point gates need to be positioned symmetrically to uniformly inject the molten resin.

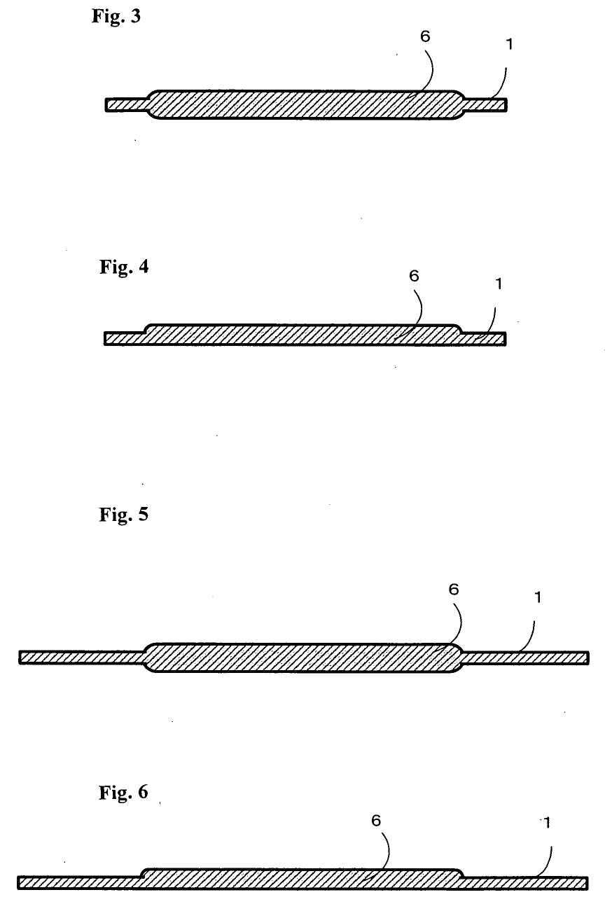

FIG. 3 is the A-A′ cross-sectional view in FIG. 1 showing dam/discharge ribs 6 which are provided on the both surfaces of thin flat plate 1 to accumulate the molten resin temporarily before discharging it to thin flat plate 1. As the volume of the molten resin increases, the discharging force of dam/discharge ribs 6 increases, thus allowing thin molding causing little warpage or shrinkage. Furthermore, the molding speed accelerates and the number of molding shots also increases; these are merits.

FIG. 4 is an alternate A-A′ cross-sectional view in FIG. 1 showing dam/discharge ribs 6 which are provided to one of the surfaces of thin flat plate 1. Although it depends on the shape of the product, the dam/discharge ribs that exist only on a single surface generate less accumulation pressure or discharging force than those formed on two surfaces; this works as an advantage for thin molding in which a mold with single-faced carving can be used, which is a productional advantage.

FIGS. 5 and 6 are alternate B-B′ cross-sectional views in FIG. 2 respectively showing dam/discharge ribs 6 which are provided either on both surfaces as well as those provided on a single surface to accumulate the molten resin injected before discharging it to thin flat plate 1 during molding. The same effects that are described for FIGS. 3 and 4 are obtained in these embodiments.

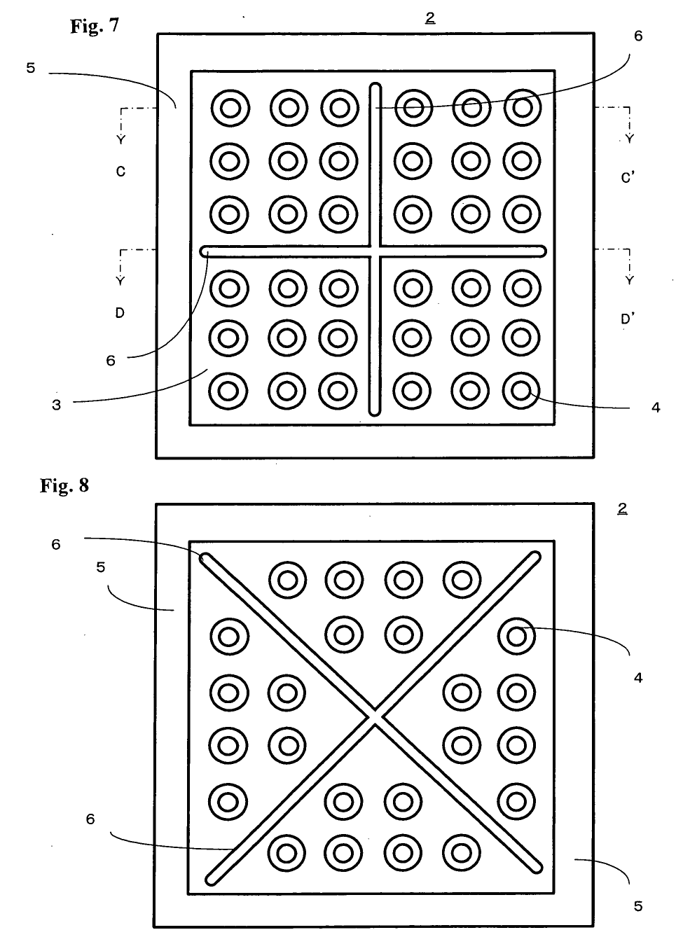

FIG. 7 is a top view of another embodiment which is associated with a thin carrying container for protectively transporting metallic shafts and the like. The thin carrying container comprises cylindrical hollow housing sections 4 on top surface 3 of thin box 2 having flange 5 along its periphery to house the tips of metallic shafts and the like. These housing sections 4 are tapered in such a manner that the open section is larger than the bottom section to make it easier to house the tips of metallic shafts and the like. Among multiple housing sections 4, cross-shaped dam/discharge ribs 6 are formed. These dam/discharge ribs 6 also allow the molten resin to spread throughout the molded article during molding very effectively because they are not only thin flat plates but also fully molded with a plurality of housing sections 4. In addition, the resin tends to fill the periphery of flange sections 5 incompletely. High-pressure injection of a resin to flange section 5 in an attempt to prevent the resin from incomplete filling tends to generate burrs. Yet the use of dam/discharge ribs 6 effectively prevents the resin from incomplete filling or burr generation.

Other application examples include protective cases which are used for hanging display of figure skates and the like, and display case/container for small containers for eggs or batteries, and the like. This example is particularly useful for a thin molded article or a case for casing and protecting contained articles that require a certain degree of strength. This type of molded article is made of a thin plate of about 0.8 mm or 0.3 mm thick. By adopting the technology of the present invention, the contained article can be protected even if it falls from a display shelf and the like at a height of about one meter.

FIG. 8 is X-shaped dam/discharge ribs 6 of FIG. 7, and the same effects that are described for FIG. 7 are applicable to this embodiment. Moreover, as described in FIG. 2, the X-shaped dam/discharge ribs in effect promote the resin flow toward top surface 3 of box 2, or toward the corners or periphery of flange sections 5.

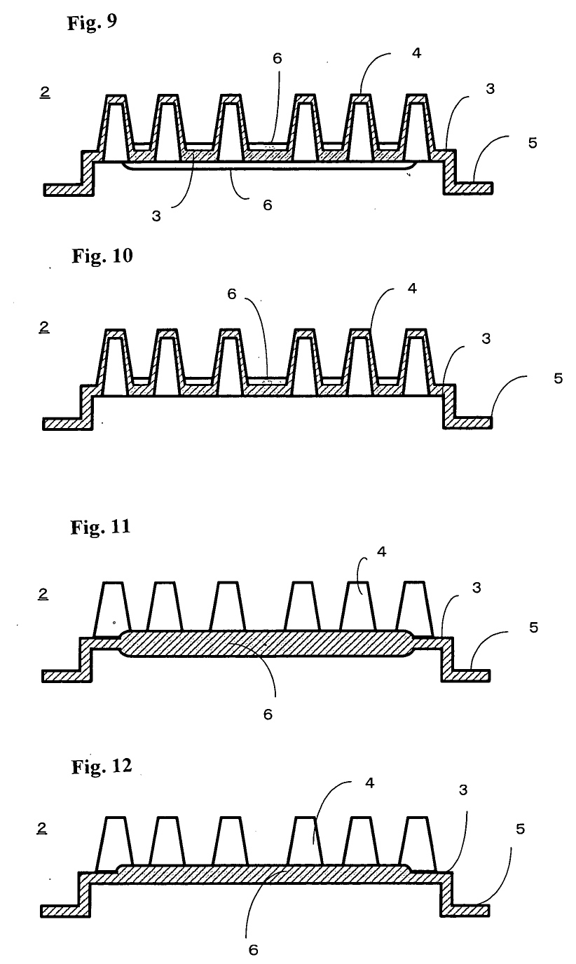

FIG. 9 is the C-C′ cross-sectional view in FIG. 7 showing hollow housing sections 4 on top surface 3 of box 2. Metallic shafts and the like are housed in these housing sections. In addition, on both front and back surfaces of top surface 3 are formed cross-shaped dam/discharge ribs 6. Flange section 5 is formed on the outer edge of box 2.

FIG. 10 is an alternate C-C′ cross-sectional view in FIG. 7, which is different from FIG. 9 in that dam/discharge ribs 6 are formed only on one side of top surface 3.

FIG. 11 is the D-D′ cross-sectional view in FIG. 7 showing hollow housing sections 4 on top surface 3 of box 2. Metallic shafts and the like are housed in these housing sections. In addition, on both front and back surfaces of top surface 3 are formed cross-shaped dam/discharge ribs 6. Flange sections 5 are provided on the outer edge of box 2.

FIG. 12 is an alternate D-D′ cross-sectional view in FIG. 7, which is different from FIG. 11 in that dam/discharge ribs 6 are provided only on one side of top surface 3.

FIG. 14 is the E-E′ cross-sectional view in FIG. 13 showing dam/discharge rib 6 of a large diameter rib having a semicircular shape.

FIG. 15 is an alternate E-E′ cross-sectional view in FIG. 13 showing dam/discharge rib 6 of a large diameter rib having a semioval (semielliptical) shape.

FIG. 16 is another alternate E-E′ cross-sectional view in FIG. 13 showing dam/discharge rib 6 of a large diameter rib having a trapezoidal shape.

FIG. 16 is still another E-E′ cross-sectional view in FIG. 13 showing dam/discharge rib 6 of a large diameter rib having a triangular shape.

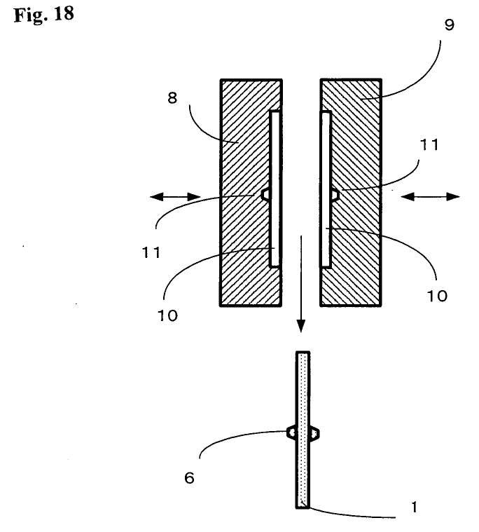

These shapes of dam/discharge ribs 6 may be varied in accordance with the type of molded article on an as-needed basis. In order to remove molded articles that resist removal, the triangular shape as shown in FIG. 17 may be considered; in order to enhance the discharging force of the molten resin, the trapezoidal shape as shown in FIG. 16 may be considered. In order to cut the mold at ease during mold manufacturing, semicircular shape allows the general shape of end mills for cutting and milling or cutting chips to fit therein.

FIG. 18 is a cross-sectional view of the mold required for molding a flat plate of the present invention. Flat plate concavities 10 and dam/discharge rib grooves 11 that are required for producing thin flat plates are formed on each upper mold 8 and lower mold 9. Pressing upper mold 8 and lower mold 9 together molds thin flat plate 1 with dam/discharge ribs 6. In this figure, the molding using a mold with double-faced carving is illustrated. However, the molding may use a single-faced carving in which flat plate concavities 10 and dam/discharge rib grooves 11 are formed only on upper mold 8.

Nevertheless, double-faced carving is more advantageous in view of removal from the mold for the following reasons. After injecting a molten resin, when an equal load is applied to the upper and lower molds having the same configuration, removing the article from the mold requires the same load. Therefore, the use of synchronized removal operation allows thin flat plate 1 to be removed from the mold at ease in the absence of pushing pins. Hence, this method eliminates the need for pushing pins to normally remove the mold; which makes mold manufacturing simpler, eliminates deformation of molded articles caused by pushing operation, and increases the number of molding shots.

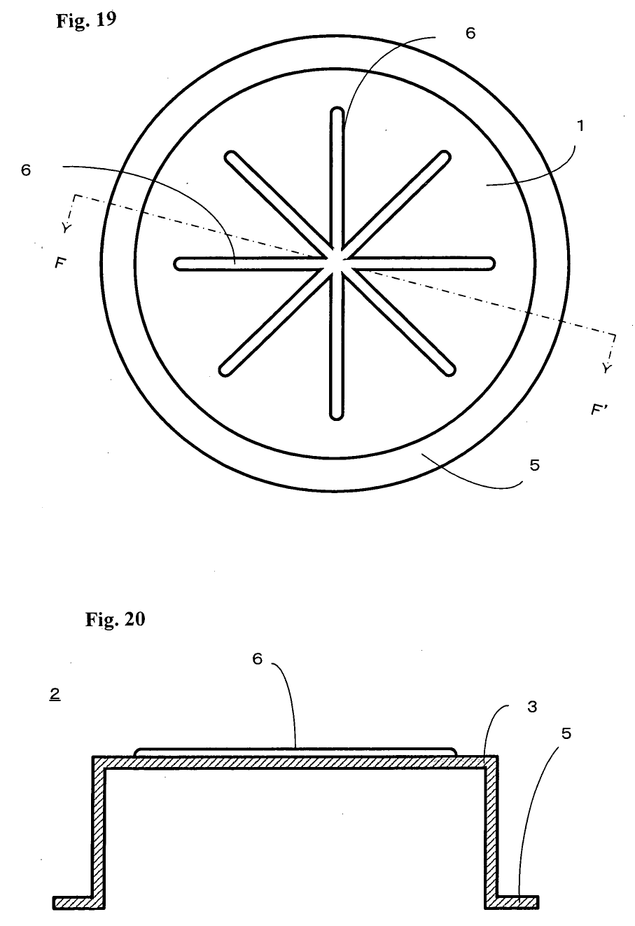

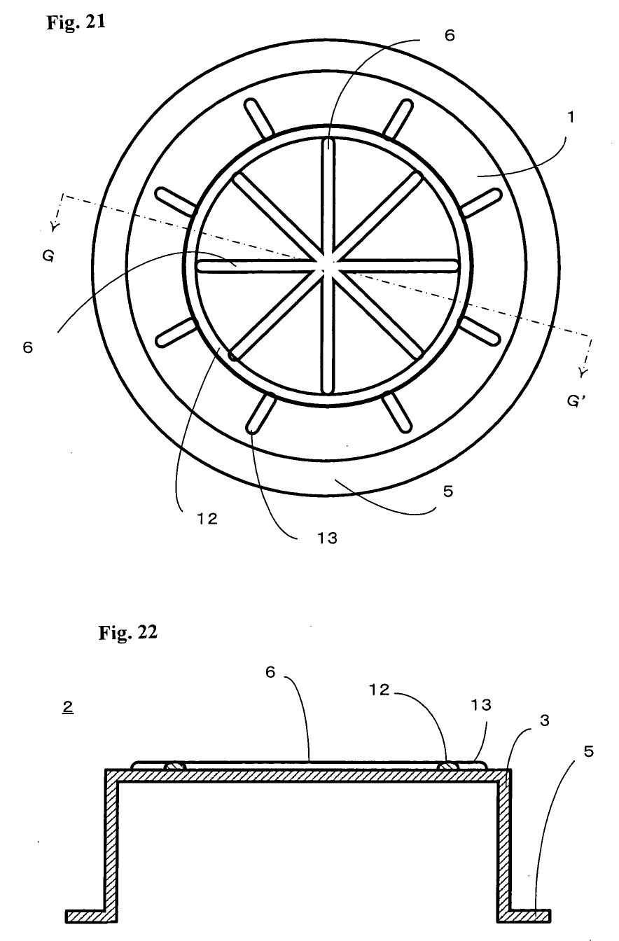

FIGS. 19 and 20 are a plan view and a cross-sectional view, respectively, of a cylindrical thin molded article with a flange. As shown in FIG. 19, eight (8) large-diameter bar-type dam/discharge ribs 6 are provided radially onto thin flat plate 1. The molten resin is accumulated temporary on these eight dam/discharge ribs 6, followed by discharging of an injection resin toward the circumference of the thin flat plate; in order to avoid thickness variations at the circumferential sections simultaneously, the molten resin is uniformly filled into thin flat plate through eight radial dam/discharge ribs 6. For the formation of a ultra-thin molded article of a thickness of 0.4 mm or more, it is effective to increase the number of dam/discharge ribs 6 on an as-needed basis. FIG. 20 is the F-F′ cross-sectional view in FIG. 21.

FIGS. 21 and 22 are a plan view and a cross-sectional view, respectively, of a cylindrical thin molded article with a flange. As shown in FIG. 21, eight large-diameter bar-type dam/discharge ribs 6 further comprise ring-shaped flow ribs 12 and bar-type auxiliary flow ribs 13. This configuration is intended to prevent thickness variations in the circumferential sections in the circumferential direction of the thin flat plate without increasing the number of dam/discharge ribs. By forming ring shaped flow ribs 12 in such a way that they enclose each of the tips of dam/discharge ribs 6 arranged radially, ring-shaped flow ribs 12 work in such a way that they receive the molten resin from dam/discharge ribs 6 and allow the molten resin to flow in the circumferential direction of thin flat plate 1. Moreover, in order to increase the fluidity of the molten resin, short bar-type auxiliary flow ribs 13 are coupled radially with the outer circumference of ring-shaped flow ribs 12. Hence, enhancement of the fluidity and prevention of thickness variation in the circumferential direction of thin flat plate 1 are achieved at the same time. FIG. 22 is the G-G′ cross-sectional view in FIG. 21.

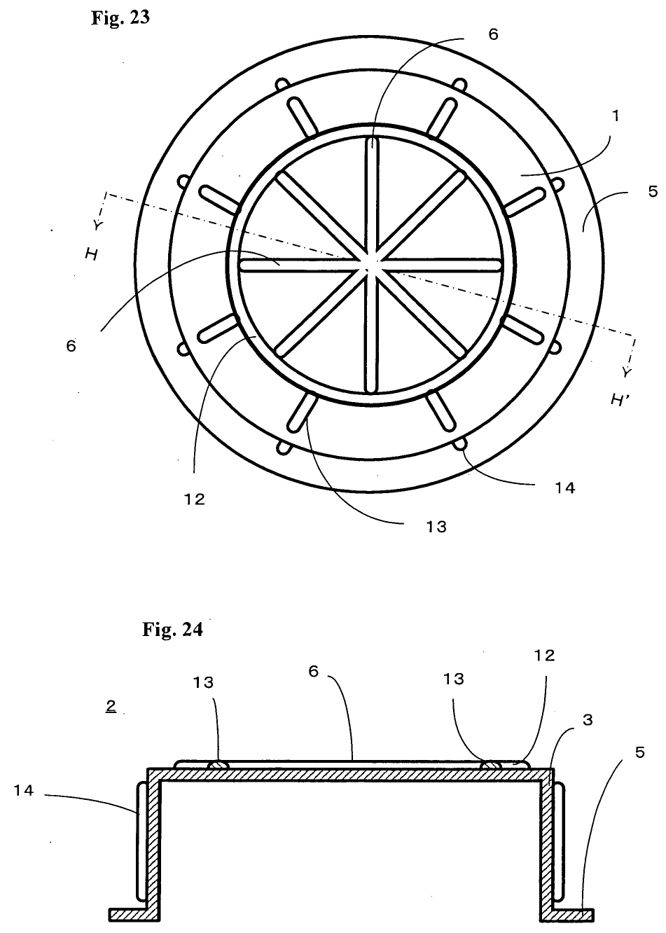

FIGS. 23 and 24 are a plan view and a cross-sectional view, respectively, of a cylindrical thin molded article with a flange. As shown in FIG. 23, side wall flow ribs 14 are provided on the side walls of a cylindrical thin mold article. Dam/discharge ribs 6, ring-shaped flow ribs 12, and auxiliary flow ribs 13, which are provided onto the top plate of the cylindrical thin molded article, can prevent the resin from incomplete filling or thickness variations. Nevertheless, since side walls are the area where the flow of the molten resin slows down, they require a structure that assists the flow. Side walls, which generally have no gates, are not allowed to have dam/discharge ribs. Therefore, the flow of the molten resin being discharged from dam/discharge ribs 6 of the top plate is assisted by side wall flow passages 14 which are provided on side walls. This is effective for large molded articles or extremely thin molded articles. FIG. 24 is the H-H′ cross-sectional view in FIG. 23.

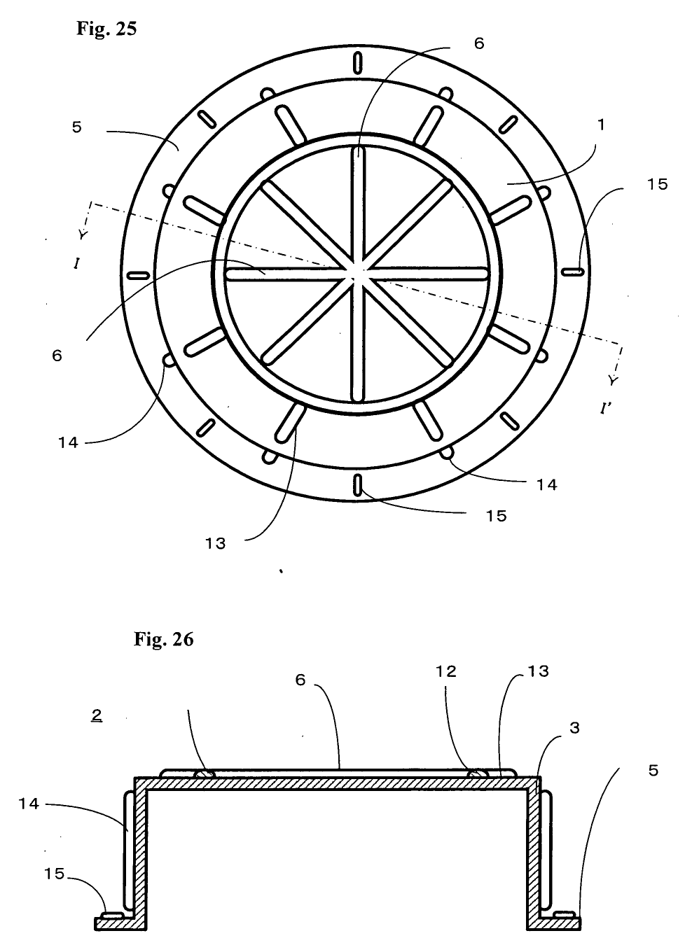

FIGS. 25 and 26 are a plan view and a cross-sectional view, respectively, of a cylindrical thin molded article with a flange. As shown in FIG. 25, flange section flow ribs 15 are provided to the flange section of the cylindrical thin molded article. In the same manner as described above, the flow of the molten resin, which was discharged from dam/discharge ribs 6 of the top plate, is assisted by side wall flow passages 14 which are formed on side walls and also by the flange section. A thin molded article has poor strength by all means; therefore, auxiliary dam/discharge ribs 13, side wall flow ribs 14 and flange section flow ribs 15 are also employed to strengthen molded articles. FIG. 26 is the I-I′ cross-sectional view in FIG. 25.

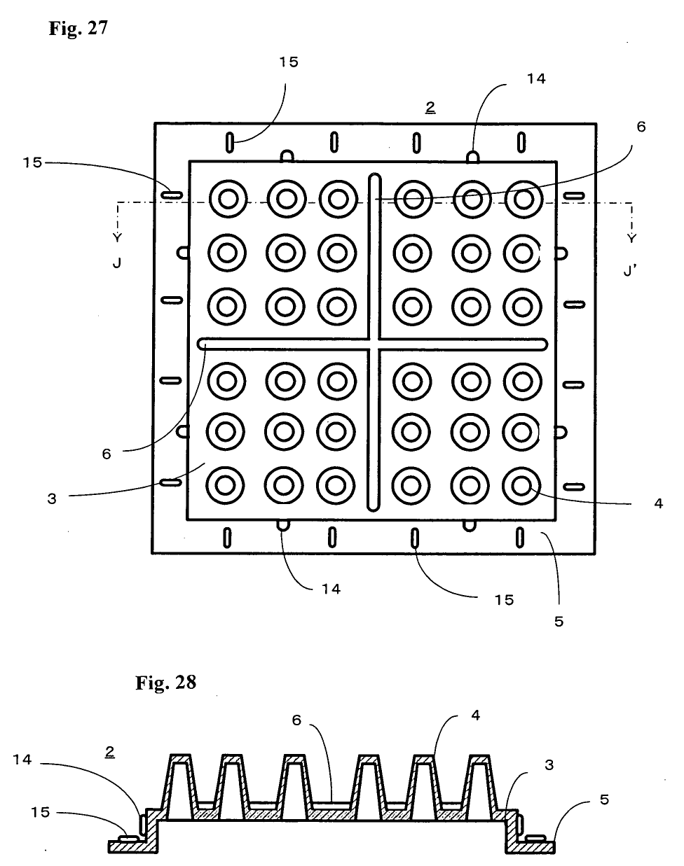

FIGS. 27 and 28 are a plan view and a cross-sectional view, respectively, of a rectangular parallelepiped thin molded article. A plurality of flange section flow ribs 15 are formed on flange section 5. The effects from operation remain the same as those of FIG. 25. In thin molding of a box, whether it is in a cylindrical or rectangular parallelepiped shape, the fluidity toward the periphery such as flange section becomes poor; as a result, in the absence of a complementary structure, the box will be susceptible to deformation, thus decreasing the product value. In this sense also, flange section dam/discharge ribs 15 work to increase the product value. Since the tips of flange section-dam/discharge ribs 15 are formed so as not to reach the periphery of flange section 5, there is some accumulation effect found in dam/discharge ribs 6. This resolves the issue of incomplete filling or thickness variations in flange section 5. FIG. 28 is the J-J′ cross-sectional view in FIG. 27.

Reference Symbols

| | |
|---|---|
| 1 | Thin flat plate |
| 2 | Thin box |
| 3 | Top surface |
| 4 | Housing section |
| 5 | Flange section |
| 6 | Dam/discharge rib |
| 7 | Gate |
| 8 | Upper mold |
| 9 | Lower mold |
| 10 | Concavity |
| 11 | Dam/discharge rib groove |
| 12 | Ring-shaped flow rib |
| 13 | Auxiliary flow rib |
| 14 | Side wall flow rib |
| 15 | Flange section flow rib |

What is claimed is:

1. A thin molded article that is thin and flat which is characterized by the fact that it comprises:
(a) a thin flat plate; and
(b) dam/discharge ribs provided on said thin plate having a shape in which bar-type ribs having wide or large diameters extend radially from the center of the molded article; the tips of said bar-type ribs having wide or large diameters have a shape that allows the molten resin injected from a gate into a cast to be accumulated temporarily before it flows into said thin plate, thereby providing a configuration in which the tips of said ribs do not reach the outer edge of the molded article.

2. A thin molded plastic article in the form of a thin box is characterized by the fact that it comprises:
(a) a thin flat box; and
(b) dam/discharge ribs provided on the top surface or the bottom surface of said thin box having a shape in which wide or large diameter bar-type ribs extend radially from the center of said top surface or bottom surface in such a manner that the tips of said wide or large diameters bar-type ribs allow the molten resin injected from a gate into a cast to be accumulated temporarily before it is flowed into said thin box, thereby providing a configuration in which the tips of said ribs do not reach the outer edge of said top surface or bottom surface of the molded article.

3. A thin plastic molded article of the thin and flat box type which is characterized by the fact that it comprises:
(a) a thin box;
(b) hollow cylindrical housing sections provided on the top surface or bottom surface of said thin box to store articles and the like; and
(c) dam/discharge ribs which are provided on the top surface or bottom surface of said thin box and has a shape in which wide or large diameter bar-type ribs extend radially from the center of said top surface or bottom surface in such a manner that the tips of said wide or large diameters bar-type ribs allow the molten resin injected from a gate into a cast to be accumulated temporarily before it is flowed into said thin box, thereby providing a configuration in which the tips of said ribs do not reach the outer edge of said top surface or bottom surface; and which are provided between said hollow cylindrical housing sections.

4. A thin molded article according to claim 1 characterized by the fact that its dam/discharge ribs are in a cross shape or X-shape.

5. A thin molded article according to claim 1 characterized by the fact that the top surface or bottom surface of its thin plate or thin box structure has ring-shaped flow ribs of large diameter or wide ribs to enclose the tips of dam/discharge ribs radially extending from the center section of the molded article.

6. A thin molded article according to claim 1 characterized by the fact that the top surface or bottom surface of its thin plate or thin box structure comprises:
(a) ring-shaped flow ribs of large diameter or wide ribs which enclose the tips of dam/discharge ribs radially extending from the center section of the molded article; and
(b) auxiliary flow ribs of large diameter or wide bar-type ribs that are radially coupled with said ring shaped flow ribs.

7. A thin molded article according to claim 2 characterized by the fact that the side walls of a thin box structure have a plurality of side wall flow ribs of large diameter or wide bar-type ribs having a shape in which the tips of said ribs do not reach the outer edge of the side walls.

8. A thin molded article according to claim 2 characterized by the fact that it has a plurality of flange section flow ribs of large diameter or wide bar-type ribs having a shape in which the tips of said ribs do not reach the outer edge of the side walls or flange section.

9. A thin molded article according to claim 2 characterized by the fact that its dam/discharge ribs are in a cross shape or X-shape.

10. A thin molded article according to claim 3 characterized by the fact that its dam/discharge ribs are in a cross shape or X-shape.

11. A thin molded article according to claim 2 characterized by the fact that the top surface or bottom surface of its thin plate or thin box structure has ring-shaped flow ribs of large diameter or wide ribs to enclose the tips of dam/discharge ribs radially extending from the center section of the molded article.

12. A thin molded article according to claim 2 characterized by the fact that the top surface or bottom surface of its thin plate or thin box structure comprises:
(a) ring-shaped flow ribs of large diameter or wide ribs which enclose the tips of dam/discharge ribs radially extending from the center section of the molded article; and
(b) auxiliary flow ribs of large diameter or wide bar-type ribs that are radially coupled with said ring shaped flow ribs.

13. A thin molded article according to claim 3 characterized by the fact that the side walls of a thin box structure have a plurality of side wall flow ribs of large diameter or wide bar-type ribs having a shape in which the tips of said ribs do not reach the outer edge of the side walls.

14. A thin molded article according to claim 3 characterized by the fact that it has a plurality of flange section flow ribs of large diameter or wide bar-type ribs having a shape in which the tips of said ribs do not reach the outer edge of the side walls or flange section.
